(19) United States
(12) Patent Application Publication
(10) Pub. No.: US 2010/0121691 A1
(43) Pub. Date: May 13, 2010

(54) SYSTEM AND METHOD FOR UTILIZING NON-COMPETE ADVERTISEMENT TAGS IN AN ADVERTISEMENT SERVING SYSTEM

(75) Inventors: Scott Shifflett, Burbank, CA (US); Steven Hartman, Hermosa Beach, CA (US); Matthew Plummer, Porter Ranch, CA (US); Margaret Shih, Burbank, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: Yahoo! Inc., Sunnyvale, CA (US)

(21) Appl. No.: 12/268,518

(22) Filed: Nov. 11, 2008

(51) Int. Cl. G06Q 30/00; G06Q 90/00

(52) U.S. Cl. 705/14.4

(57) ABSTRACT

Generally, embodiments of the present invention provides for methods, systems and computer program products for utilizing non-compete advertisement tags in an advertisement serving system. The method according to one embodiment of the present invention comprises identifying one or more web pages that contain a first advertisement tag and selecting a given web page from the one or more web pages. A second inactive advertisement tag is then inserted into the web page, which requests an advertisement for the web page that is subsequently ignored. The method further comprises monitoring a number of impressions the web page receives using the second advertisement tag in order to determine a traffic forecast. The method further comprises setting the second advertisement tag to an active status, causing the first advertisement tag from the web page to be removed and an advertisement to be returned in response to the request by the second advertisement tag.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to advertisement tags. More specifically, the present invention provides systems, methods and computer program products for utilizing non-compete advertisement tags in an advertisement serving system.

### BACKGROUND OF THE INVENTION

The World Wide Web provides access to an extraordinary large collection of information sources (in various formats including text, images, videos and other media content) relating to virtually every subject imaginable. Advertising has become the economic foundation of the World Wide Web, with nearly all non-transactional websites relying on revenue generated by the placement of advertisements on their website as a primary source of income. Traditionally, advertisers have a pre-existing agreement with a website operator or a search engine provider to display online advertisements in association with one or more selected web pages. Online advertisements are usually displayed on web pages as a result of a request for one or multiple advertisements by advertisement tags that are associated with web pages provided by publishers. The requests for advertisements and the subsequent display on web pages are usually handled by an ad serving system.

However, as online advertising continues to grow, so too does the number of available ad serving systems that may be offered by different content providers. Due to several obvious factors, such as cost or features offered, publishers may continuously changes what ad serving system they utilize in order to deliver on line advertising. From the publisher's vantage point, the change to different ad serving systems results in a disjointed transition between service of the ad serving systems because the transition requires the removal of the advertisement tag in a legacy ad server system and the introduction of a new advertisement tag associated with the new advertisement system. The result is a period of time where the web page cannot be displayed to perform such maintenance, or if it can be displayed, will not be displayed with an advertisement. In either scenario, the publisher of the web page suffers lost advertising revenue.

From the advertiser's and the ad serving system's vantage point, the transition of a publisher to a new ad serving system will result in period of time where there exists no traffic data for the publisher's web page because there is no history as the amount of traffic the web page receives. As a result, the ad serving system and the advertiser has difficultly in forecasting the amount of traffic the web page will receive, which may ultimately translate in to lost revenue for the advertiser.

Therefore, a need exists for improved systems, methods and computer program products that allow for a seamless transition for a publisher's web page between ad serving systems, as well as allow for the collection of traffic data to accurately forecast traffic of the publisher's webpage as it transitions between ad serving systems.

### SUMMARY OF THE INVENTION

Generally, embodiments of the present invention provide for methods, systems and computer program products for utilizing non-compete advertisement tags in an advertisement serving system. One embodiment of the present invention is directed towards a method for integrating an advertisement tag in a web page that comprises identifying one or more web pages that contain a first advertisement tag and selecting a given web page from the one or more web pages that contain the first advertisement tag. A second advertisement tag is then inserted into the given web page, wherein the second advertisement tag comprises an activity status set as inactive. The second advertisement tag requests an advertisement for the web page, which is subsequently ignored. The method further comprises monitoring a number of impressions the web page receives using the second advertisement tag and determining a traffic forecast for the web page based upon the number of impression the web page receives.

The method may also comprise setting the activity status of the second advertisement tag as active, which may cause the first advertisement tag from the web page to be removed. According to another embodiment, the first advertisement tag may be removed by the publisher of the web page. As a result of the removal of the first advertisement tag, an advertisement is returned in response to the request for the advertisement by the second advertisement tag.

In providing for the integration of non-compete advertisement tags in web page, embodiments of the present invention provide solutions to the need for a seamless transition for a publisher's web page between ad serving systems, as well as allow for the collection of traffic data to accurately forecast traffic of the publisher's webpage as it transitions between ad serving systems.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of a system for integrating a non-compete advertisement tag in a web page according to one embodiment of the present invention;

FIG. 2 illustrates a flow diagram presenting a method for integrating a non-compete advertisement tag in a web page according to one embodiment of the present invention;

FIG. 3 illustrates a flow diagram presenting a method for integrating a non-compete advertisement tag in a web page in relation to the existing advertisement tag according to one embodiment of the present invention; and

FIG. 4 illustrates a flow diagram presenting a method for integrating a non-compete advertisement tag in a web page according to another embodiment of the present invention.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

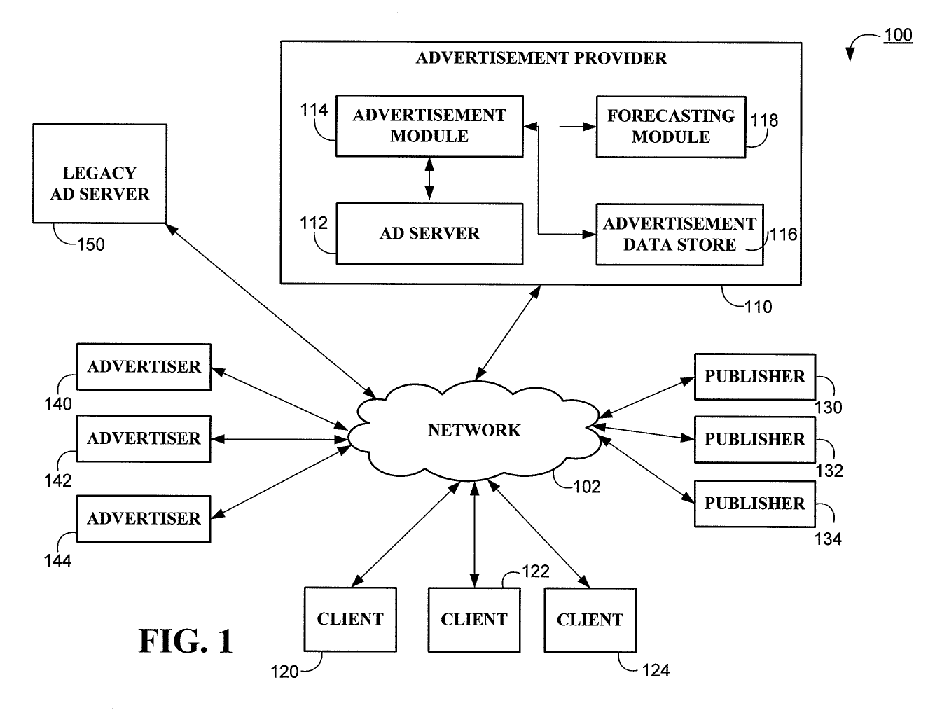

FIG. 1 illustrates one embodiment of a system 100 for integrating a non-compete advertisement tag in a web page, the system 100 includes a computer network 102, an advertisement provider 110, a first client 120, a second client 122 and a third client 124, a first publisher 130, a second publisher 132 and a third publisher 134, a first advertiser 140, a second advertiser 142 and a third advertiser 144, and a legacy ad server 150. In the present embodiment, the advertisement provider 110 comprises an ad server 112, an advertisement module 114, an advertisement data store 116 and a forecasting module 118.

The computer network 102 may be any type of computerized network capable of transferring data, such as the Internet. According to one embodiment of the invention, the first client device 120, the second client device 122 and the third client device 124 are general purpose personal computers comprising a processor, transient and persistent storage devices, input/output subsystem and bus to provide a communications path between components comprising the general purpose personal computer. Other client devices are considered to fall within the scope of the present invention including, but not limited to, hand held devices, set top terminals, mobile handsets, PDAs, etc. The present invention is not limited to only the client devices 120, 122 and 124 and may comprise additional, disparate client devices. The client devices 120, 122 and 124 are therefore presented for illustrative purposes representative of multiple client devices.

According to one embodiment of the invention, the ad server 112, the publishers 130, 132 and 134, the advertisers 140, 142 and 144 and the legacy ad server 150 are programmable processor-based computer devices that include persistent and transient memory, as well as one or more network connection ports and associated hardware for transmitting and receiving data on the network 102. The ad server 112, the publishers 130, 132 and 134, the advertisers 140, 142 and 144 and the legacy ad server 150 may host websites, store data, serve ads, etc. Those of skill in the art understand that any number and type of content server 112, the publishers 130, 132 and 134, the advertisers 140, 142 and 144 and the ad server 150 may be connected to the network 102.

The advertisement module 114 and the forecasting module 118 may comprise one or more processing elements operative to perform processing operations in response to executable instructions, collectively as a single element or as various processing modules, which may be physically or logically disparate elements. The advertisement data store 116 may be one or more data storage devices of any suitable type, operative to store corresponding data therein. Those of skill in the art recognize that the content provider 110 may utilize more or fewer components and data stores, the content provider 100 may be local or remote with regard to another given component or data store.

In accordance with one embodiment, client devices 120, 122 and 124, the publishers 130, 132 and 134, the advertisers 140, 142, and 144, the legacy ad server 150 and the advertisement provider 110 are communicatively coupled to the computer network 102. The client devices 120, 122 and 124 may communicate across the network 102 to the publishers 130, 132 and 134 in order to access one or more web documents maintained by the publishers 130, 132 and 134, such as news website, an online shopping website, an auction website, a blog website, etc.

The web documents maintained by the publishers 130, 132 and 134 may contain data indicating a location to which requests are to be delivered for one or more advertisements to be displayed at the web documents located at the publishers 130, 132 and 134 and selected by the clients 120, 122 and 124. For example, a given website located at the first publisher 130, the second publisher 132 or the third publisher 134 may contain an advertisement tag, such as HTML tags or JavaScript code, identifying a location to which requests are to be delivered for one or more advertisements to be displayed at the publishers 130, 132 and 134. When a given website on the first publisher 130, the second publisher 132 or the third publisher 134 is visited by a user of a client device 120, 122 and 124, which may be as a result of the search request or as a result of the user entering a URL, a request may be delivered from the client device 120, 122 or 124 to the location specified by the advertisement tags.

According to one embodiment of the invention, a request for one or more advertisements to be displayed at a given website of the first publisher 130, the second publisher 132 or the third publisher 134 is delivered to the legacy ad server 150. The legacy ad server 150 is operative to search its repository of advertisements in order to identify and select one or more advertisements for display at a given website of the first publisher 130, the second publisher 132 or the third publisher 134. For example, the legacy ad server 150 may select one or more advertisements from its repository on the basis of the content of the selected website of the first publisher 130, the second publisher 132 or the third publisher 134 at which the one or more advertisements are to be displayed, as indicated by the request received from the first publisher 130, the second publisher 132 or the third publisher 134. The one or more advertisements that are selected are then transmitted for display by the legacy ad server 150 at the selected website of the first publisher 130, the second publisher 132 or the third publisher 134 on the client device 120, 122 or 124.

According to one embodiment of the invention, the request for one or more advertisements to be displayed at a given website of the first publisher 130, the second publisher 132 or the third publisher 134, is also received by the ad server 112 of the advertisement provider 110, which may be acknowledged by the advertisement module 114. Upon identifying the request, the advertisement module 114 places a second additional advertisement tag, which may be referred to as a non-compete advertisement tag, such as an HTML tag or JavaScript code, on the given website of the first publisher 130, the second publisher 132 or the third publisher 134. According to another embodiment, the non-compete advertisement tag is placed on the given website by the first publisher 130, the second publisher 132 or the third publisher 134. The non-compete advertisement tag will also be operative to indicate a location which requests are to be delivered for one or more advertisements to be displayed at the publishers 130, 132 and 134, just as the legacy or first advertisement tag does. In subsequent requests for one or more advertisements to be displayed at a given website of the first publisher 130, the second publisher 132 or the third publisher 134, once the request for one or more advertisement is made, the request is delivered to both the legacy ad server 150 and the advertisement module 114 at the advertisement provider 110.

The non-compete advertisement tag on the given website of the first publisher 130, the second publisher 132 or the third publisher 134 is set to an inactive status. For example, the non-compete advertisement tag comprises additional executable code, such as HTML code or JavaScript code, which indicates that the second advertisement tag is inactive. In subsequent requests for one or more advertisements to be displayed at a given website of the first publisher 130, the second publisher 132 or the third publisher 134 that are transmitted to the advertisement module 114, the advertisement module 114 is operative to identify that the given website contains the non-compete advertisement tag set as inactive. Identifying the inactive non-compete advertisement tag will cause the advertisement module 114 to transmit an alert to the forecasting module 118 of the content provider 110, indicating that a request has been made for one or more advertisements to be displayed at a given website of the first publisher 130, the second publisher 132 or the third publisher 134. The forecasting module 118 records the request as an impression of the given website. In subsequent requests, the forecasting module 118 will continue to monitor and record the number of requests as a number of impressions. The forecasting module 118 uses the number of impressions to generate one or more forecasting traffic reports for the given website as is known in the art.

According to one embodiment of the invention, the advertisement module 114 is operative to set the non-compete advertisement tag to an active status. For example, the advertisement module 114 is operative to add executable code at the instruction of an individual, such as HTML code or JavaScript code, to the non-compete advertisement tag to indicate that the non-compete advertisement tag is active. The publisher 130, 132 and 134 may instruct the advertisement module 114 to add the add the executable code to the non-compete advertisement tag through preset functions of a user interface or by manipulation of the execution code itself using the user interface via the network 102. As part of the activity in setting the non-compete advertisement tag to an active status, the advertisement module 114 is operative to remove the first advertisement tag from the given website. According to another embodiment, the non-compete advertisement tag is set as active and the first advertisement tag is removed from the given website by the first publisher 130, the second publisher 132 or the third publisher 134.

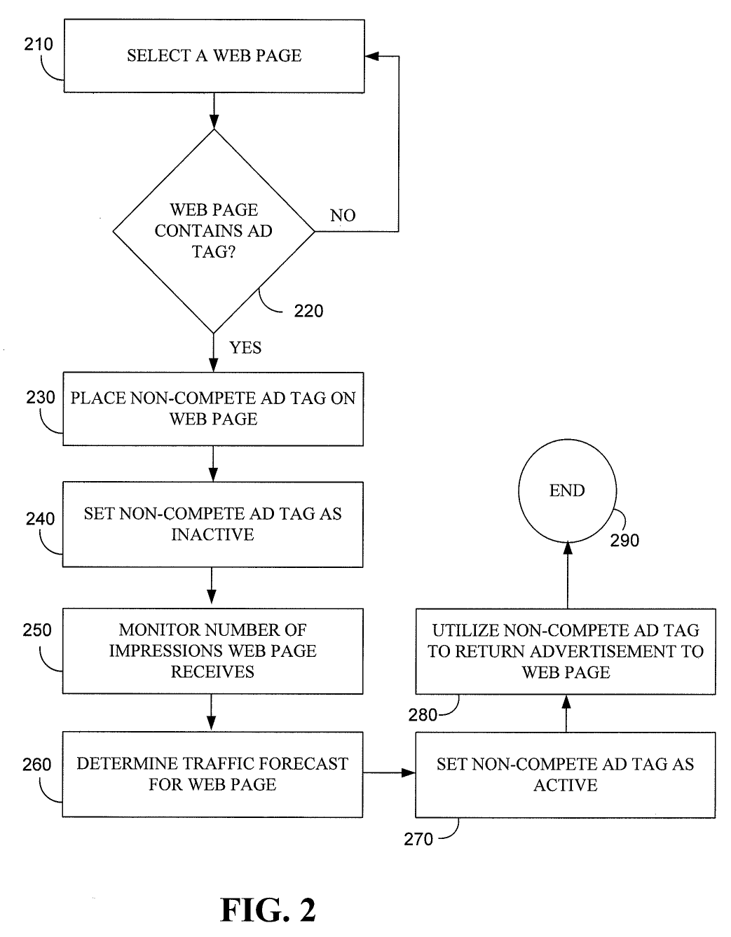

In subsequent requests for one or more advertisements to be displayed at the given website of the first publisher 130, the second publisher 132 or the third publisher 134, the requests continue to be delivered to the advertisement provider 110. By virtue of the fact that the given website contains an active non-compete advertisement tag without a first advertisement tag, subsequent requests are transmitted to solely the advertisement module 114 at the advertisement provider 110 and are no longer transmitted to the legacy server 150 The advertisement module 114 recognizes that the non-compete advertisement tag is now active, causing the advertisement module 114 to search the advertisement data store 116 of the content provider 110, which stores one or more advertisements transmitted by the advertisers 140, 142 and 144, to identify and select one or more advertisements for display at a given website of the first publisher 130, the second publisher 132 or the third publisher 134. For example, the advertisement module 114 may select one or more advertisements from the advertisement data store 116 on the basis of the content of the selected website of the first publisher 130, the second publisher 132 or the third publisher 134, at which the one or more advertisements are to be displayed, as indicated by the request received from the first publisher 130, the second publisher 132 or the third publisher 134. The one or more advertisements that are selected are then transmitted for display by the advertisement module 114 via the ad server 112 at the selected website of the first publisher 130, the second publisher 132 or the third publisher 134 on the client device 110, 115 or 120. Methods for integrating a non-compete advertisement tag in a web page are described in greater detail below with respect to the description of FIGS. 2 through 4.

According to one embodiment of the present invention, when setting the non-compete advertisement tag to an active status, the advertisement module 114 will continue to transmit an alert to the forecasting module 118 of the content provider 110, indicating that a request has been made for one or more advertisements. The forecasting module 118 will thus continue to monitor and record the number of requests for advertisements as a number of impressions in order to generate one or more forecasting traffic reports for a given website as is known in the art.

FIG. 2 illustrates a flow diagram presenting a method for integrating a non-compete advertisement tag in a web page according to one embodiment of the present invention. In accordance with the embodiment of FIG. 2, the method may begin by selecting a web page, step 210. For example, a web page offered by a publisher that contains a sports news article relating to the New York Giants football team winning Super Bowl XLII is selected for this process by the publisher. A determination is then made as to whether the selected web page contains an advertisement tag, step 220. For example, the web page provided by the publisher for the sports news article may contain an advertisement tag identifying a location to which requests are to be delivered for one or more advertisements to be displayed at the publisher's web page. If the web page does not contain an advertisement tag, process flow is returned to step 210; otherwise, process flow continues to step 230, where a non-compete advertisement tag is placed on the web page. Continuing from the previous example, an advertisement provider offering advertisement serving services or the publisher of the web page containing the sports news article may place a second advertisement tag or non-compete advertisement tag on the selected web page.

The non-compete advertisement tag is set to inactive status, step 240. For example, the non-compete advertisement tag may contain additional executable code that would alert a content provider offering advertisement serving services that the second non-compete advertisement tag has an inactive status and that the content provider should not return an advertisement in response to the associated request. The number of impressions the web page receives is monitored and recorded, step 250, and a traffic forecast for the web page is determined, step 260. Continuing from the previous example, the content provider acknowledges that the second non-compete advertisement tag is set to inactive status, which prompts the content provider to record the request for an advertisement as an impression. The content provider may then continue to monitor requests for advertisements by virtue of the existence of the second non-compete advertisement tag on the selected web page as the number of impressions the web page receives. The content provider may use the number of impressions in order to generate one or more traffic forecast reports for the selected web page containing the news article.

The non-compete advertisement tag is then set to an active status, step 270. Continuing from the previous example, the content provider offering advertisement serving services or the publisher of the web page containing the sports news article may set the non-compete advertisement tag on the selected web page to an active status, which alerts the content provider that one or more advertisements are to be returned to the selected web page. At step 280, the non-compete advertisement tag now set as active is utilized to return one or more advertisements to the selected webpage and the process terminates at step 290. According to one embodiment of the present invention, once the non-compete advertisement tag is set to an active status, the original advertisement tag or legacy advertisement tag is removed from the web page. Otherwise, if the legacy advertisement tag is not removed, the non-compete advertisement tag would be competing to the legacy advertisement tag in returning one or more advertisement, resulting in a competitive environment

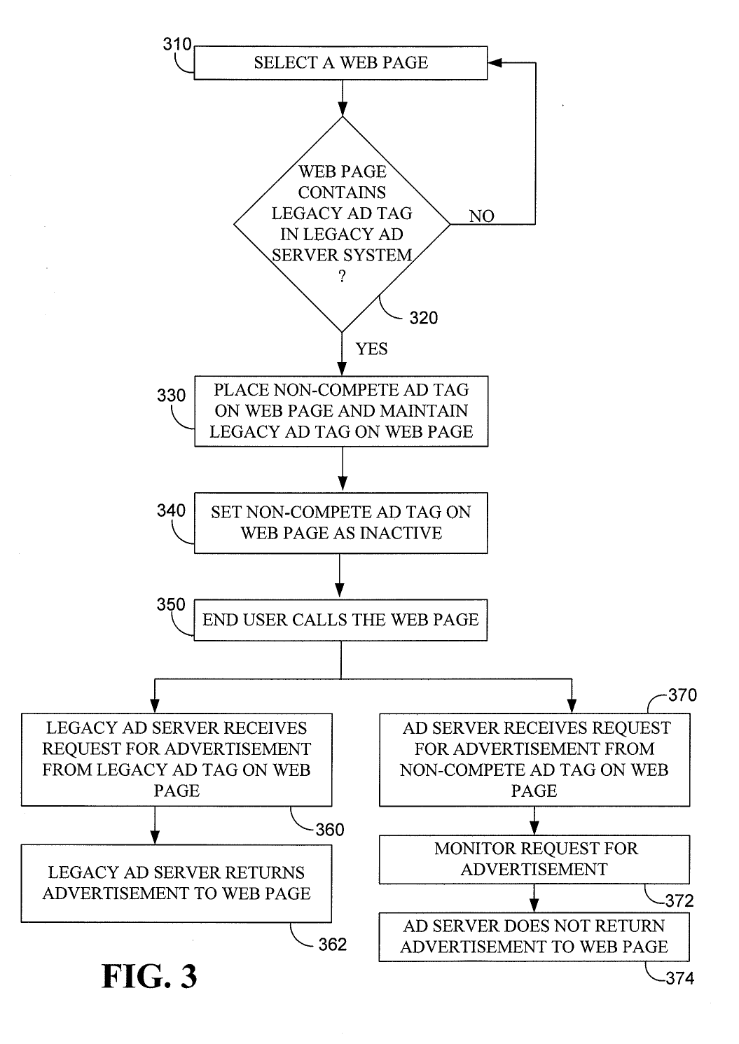

FIG. 3 illustrates a flow diagram presenting a method for integrating a non-compete advertisement tag in a web page in relation to the existing advertisement tag according to one embodiment of the present invention. In accordance with the embodiment of FIG. 3, the method may begin by selecting a web page, step 310. As demonstrated in the previous example, a web page offered by a publisher that contains a sports news article relating to the “New York Giants” is selected by the publisher to undergo this process. A determination is then made as to whether the selected web page contains a legacy advertisement tag in a legacy ad server system, step 320. For example, the web page provided by the publisher for the sports news article may contain a legacy advertisement tag associated with a legacy ad server system identifying a location to which requests are to be delivered for one or more advertisements to be displayed at the publisher's web page by the legacy ad server system. If the web page does not contain a legacy advertisement tag, process flow is returned to step 310; otherwise, process flow continues to step 330, where a non-compete advertisement tag is placed on the web page, while maintaining a legacy advertisement tag on the web page. Continuing from the previous example, a content provider offering advertisement serving services or the publisher of the web page containing the sports news article may place a second advertisement tag or non-compete advertisement tag on the selected web page while maintaining the existing legacy advertisement tag on the web page.

The non-compete advertisement tag is set to inactive status, step 340. As set forth earlier, the non-compete advertisement tag may contain additional executable code that alerts a content provider offering advertisement serving services that the second non-compete advertisement tag has an inactive status and that the content provider should not return an advertisement in response to the associated request. A subsequent end user then calls the web page, step 350. Continuing from the previous example, an end user may select the web page containing the sports news article in response to her search query for “Super Bowl XLII.”

The legacy ad server system receives a request for one or more advertisements from the legacy advertisement tag on the selected web page as a result of the selection of the web page by the subsequent end user, step 360. The legacy ad server then returns one or more advertisements to the selected web page as a result of the advertisement request, step 362. For example, the legacy ad server system may return an advertisement for a ticket broker selling tickets to New York Giants home games in response to request for one or more advertisements from the legacy advertisement tag on the selected web page.

In tandem with the legacy ad server system receiving a request for one or more advertisements from the legacy advertisement tag, the ad server receives the request for advertisement from the non-compete advertisement tag on the selected web page, step 370. For example, an advertisement provider that provides an ad serving system, such as the advertisement provider 110 with the advertisement module 114 and the advertisement data store 116 of FIG. 1, which serves as the ad serving system, may receive a request for one or more advertisements from the non-compete advertisement tag. The request for the one or more advertisements are monitored, step 372, and the ad server ignores the request and does not return an advertisement, step 374. Continuing from the previous example, a content provider that provides an ad serving system, such as the advertisement provider 110 of FIG. 1, may acknowledge that the non-compete advertisement tag is inactive, monitor multiple requests for advertisements by virtue of the non-compete tag and ignore the request for one or more advertisements.

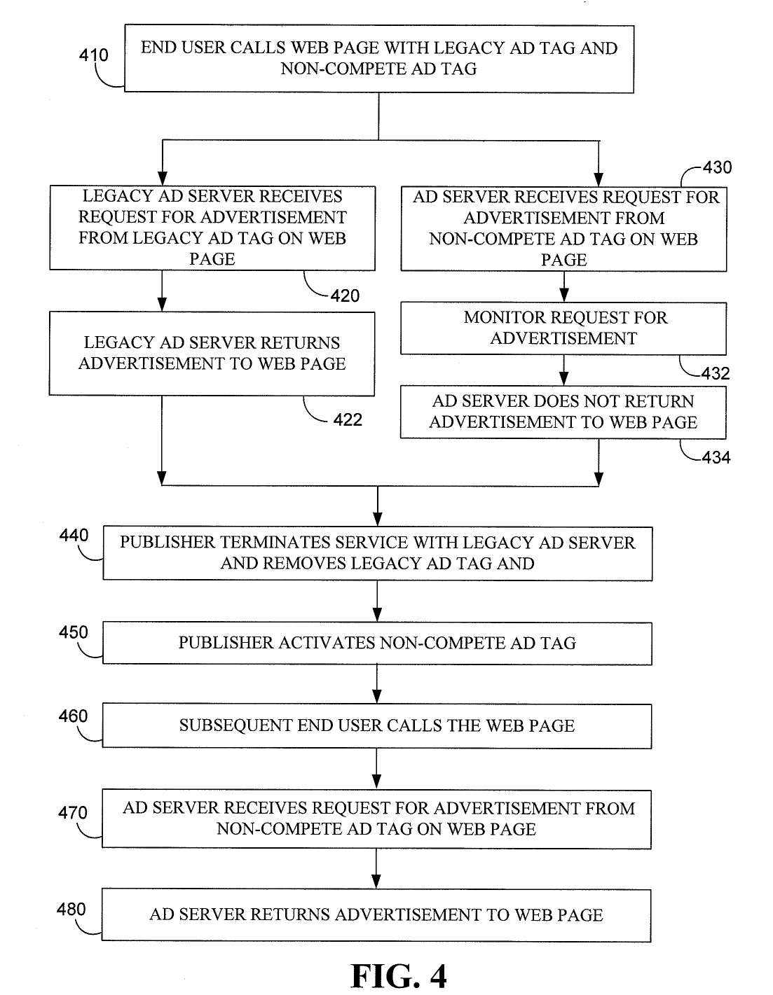

FIG. 4 illustrates a flow diagram presenting a method for integrating a non-compete advertisement tag in a web page according to another embodiment of the present invention. In accordance with the embodiment of FIG. 4, the method may begin by an end user calling a web page that has a legacy ad tag and a non-compete advertisement tag, step 410. As demonstrated in the previous example, an end user may select the web page containing the sports news article in response to her search query for “Super Bowl XLII.”

The legacy ad server system receives a request for one or more advertisements from the legacy advertisement tag on the selected web page as a result of the selection of the web page by the end user, step 420. The legacy ad server then returns one or more advertisements to the selected web page as a result of the advertisement request, step 422. For example, the legacy ad server system may return an advertisement for a ticket broker selling tickets to New York Giants home games in response to request for one or more advertisements from the legacy advertisement tag on the selected web page.

In tandem with the legacy ad server system receiving a request for one or more advertisements from the legacy advertisement tag, the ad server receives the request for advertisement from the non-compete advertisement tag on the selected web page, step 430. For example, an advertisement provider that provides an ad serving system, such as the advertisement provider 110 with the advertisement module 114 and the advertisement data store 116 of FIG. 1, which serves as the ad serving system, may receive a request for one or more advertisements from the non-compete advertisement tag.

The request for the one or more advertisements are monitored, step 432, and the ad server ignores the request and does not return an advertisement, step 434. Continuing from the previous example, a content provider that provides an ad serving system, such as the advertisement provider 110 of FIG. 1, may acknowledge that the non-compete advertisement tag is inactive, monitor multiple requests for advertisements by virtue of the non-compete tag and ignore the request for the one or more advertisements.

The publisher may then terminate service with the legacy ad server and remove the legacy advertisement tag, step 440. The publisher then activates the non-compete advertisement tag, step 440. For example, the publisher may integrate additional executable code into the non-compete advertisement tag that indicates that the non-compete advertisement tag is active. According to another embodiment of the present invention, the removal of the legacy advertisement tag and the activation of the non-compete advertisement tag may be performed by the advertisement provider at the instruction of the publisher.

A subsequent user may then call the web page, step 460. Continuing from the previous example, a subsequent end user may select the web page containing the sports news article in response to her search query for “Super Bowl XLII.” The ad server then receives the request for one or more advertisements from the onon-compete advertisement tag on the web page, step 470. The ad server, acknowledging the the non-compete advertisement tag on the web page is active, return one or more advertisements to the web page, step 480.

In accordance with the foregoing description, the present invention provides systems, methods and computer program products for utilizing non-compete advertisement tags in an advertisement serving system. In providing for the integration of non-compete advertisement tags in web page, embodiments of the present invention provide solutions to the need for a seamless transition for a publisher's web page between ad serving systems, as well as allow for the collection of traffic data to accurately forecast traffic of the publisher's webpage as it transitions between ad serving systems.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed:

1. A method for integrating an advertisement tag in a web page, the method comprising:
identifying one or more web pages that contain a first advertisement tag;
selecting a given web page from the one or more web pages that contain the first advertisement tag;
inserting a second advertisement tag into the given web page, wherein the second advertisement tag comprises an activity status set as inactive;
requesting an advertisement for the web page by the second advertisement tag; and
ignoring the request for the advertisement by the second advertisement tag.

2. The method of claim 1, wherein the first advertisement tag is associated with a separate ad serving system.

3. The method of claim 1, further comprising:
requesting the advertisement for the web page by the first advertisement tag; and
returning the advertisement in response to the request for the advertisement by the first advertisement tag.

4. The method of claim 1, further comprising:
monitoring a number of impressions the web page receives using the second advertisement tag; and
determining a traffic forecast for the web page based upon the number of impression the web page receives.

5. The method of claim 1, further comprising setting the activity status of the second advertisement tag as active.

6. The method of claim 5, wherein setting the activity status of the second advertisement tag as active comprises removing the first advertisement tag from the web page.

7. The method of claim 5, further comprising returning the advertisement in response to the request for the advertisement by the second advertisement tag.

8. Computer readable media comprising program code that when executed by a programmable processor causes the programmable processor to execute a method for integrating an advertisement tag in a web page, the computer readable media comprising:
program code for identifying one or more web pages that contain a first advertisement tag;
program code for selecting a given web page from the one or more web pages that contain the first advertisement tag;
program code for inserting a second advertisement tag into the given web page, wherein the second advertisement tag comprises an activity status set as inactive;
program code for requesting an advertisement for the web page by the second advertisement tag; and
program code for ignoring the request for the advertisement by the second advertisement tag.

9. The computer readable media of claim 8, wherein the first advertisement tag is associated with a separate ad serving system.

10. The computer readable media of claim 8, further comprising:
program code for requesting the advertisement for the web page by the first advertisement tag; and
program code for returning the advertisement in response to the request for the advertisement by the first advertisement tag.

11. The computer readable media of claim 8, further comprising:
program code for monitoring a number of impressions the web page receives using the second advertisement tag; and
program code for determining a traffic forecast for the web page based upon the number of impression the web page receives.

12. The computer readable media of claim 8, further comprising program code for setting the activity status of the second advertisement tag as active.

13. The computer readable media of claim 12, wherein setting the activity status of the second advertisement tag as active comprises program code for removing the first advertisement tag from the web page.

14. The computer readable media of claim 12, further comprising program code for returning the advertisement in response to the request for the advertisement by the second advertisement tag.

15. A system for integrating an advertisement tag in a web page, the system comprising:
an advertisement server associated with the first advertisement tag; and
an advertisement module operative to:
identify one or more web pages that contain a first advertisement tag;
select a given web page from the one or more web pages that contain the first advertisement tag;
insert a second advertisement tag into the given web page, wherein the second advertisement tag comprises an activity status set as inactive;
request an advertisement for the web page using the second advertisement tag; and
a second advertisement server operative to ignore the request for the advertisement by the advertisement module using the second advertisement tag.

16. The system of claim 15, wherein the first advertisement tag is associated with a separate advertisement serving system.

17. The system of claim 16, wherein:
the first advertisement tag is operative to request the advertisement for the web page; and
the separate advertisement serving system is operative to return the advertisement in response to the request for the advertisement by the first advertisement tag.

18. The system of claim 15, wherein the advertisement module is further operative to:
monitor a number of impressions the web page receives using the second advertisement tag; and
determine a traffic forecast for the web page based upon the number of impression the web page receives.

19. The system of claim 15, wherein the advertisement module is further operative to set the activity status of the second advertisement tag as active.

20. The system of claim 19, wherein the advertisement module is further operative to remove the first advertisement tag from the web page.

21. The system of claim 19, wherein the second advertisement server is operative to return the advertisement in response to the request for the advertisement by the advertisement module using the second advertisement tag.
